(19) United States
(12) Patent Application Publication
(10) Pub. No.: US 2009/0142414 A1
(43) Pub. Date: Jun. 4, 2009

(54) Anterminator

(75) Inventor: Charlene O'Neill, Morrisville, NC (US)

Correspondence Address: Charlene O'Neill, 3114 Kudrow Lane, Morrisville, NC, 27560, US

(73) Assignee: CHARLENE O'NEILL, Morrisville, NC (US)

(21) Appl. No.: 11/951,297

(22) Filed: Dec. 5, 2007

Related U.S. Application Data
(60) Provisional application No. 60/991,198, filed on Nov. 29, 2007.

(51) Int. Cl. A01N 59/14; A01P 7/04

(52) U.S. Cl. 424/658

(57) ABSTRACT

This invention relates to the use of mixtures of sodium tetraborate decahydrate, sodium borate, or disodium tetraborate, such as borax a white powder consisting of soft colorless crystals and, in combination with surface active agents of powdered or icing sugar and cornstarch containing fine granules of powders and crystal agents, for controlling the population of certain insects, especially ants.

### CROSS REFERENCE TO RELATED APPLICATIONS

This non-provisional application claims priority to provisional application U.S. 60/991,198 filed on Nov. 29, 2007

### BACKGROUND OF THE INVENTION

There is a large multitude of insects invading the United States and many other parts of the world in increasing numbers. The current Federal and state guidelines for the use of chemicals have been imposed in an effort to protect the environment from toxic effects of various chemicals used in pest control. Among the chemicals banned or restricted in use by governments are DDT, Chlorodane, Lindane, Aldrin, Heptechlor, Dieldrin and Mirex along with several others that were on the market. Mirex specifically was employed as an agent insecticide against ants, since this products use has been banned in the United States, the current ant population has been increasing so rapidly that ants are seen in crops, homes, parks and this has lead to major destruction of crops, infestations of homes and businesses. In addition ants have been observed killing small rodents and the ants will feed on anything that they come in contact with. They are a menace to people in homes, schools, work places, and even in medical facilities. Ants destroy lawns and burrow tunnels in the ground and can multiply and infest any buildings above the burrows that have been created. Borax has a wide variety of uses. It is a component of many detergents, cosmetics and enamel glazes. It is also used to make buffer solutions in biochemistry, as an insecticide, as a flux in metallurgy, and as a precursor for other boron compounds. The term borax is used for a number of closely related minerals or chemical compounds that differ in their crystal water content, but usually refers to the decahydrate. Commercially sold borax is usually partially dehydrated.

### PRIOR ART

The order Hymenoptera, family Formicidae includes numerous species of ants. As described in U.S. Pat. No. 4,421,759 issued to G. W. Eichhoefer on Jan. 2, 1990. This patent discloses and claims the use of Pine oil fire ant insecticide for controlling the population of certain colonial insects, especially fire ants.

Another patent directed to the control of ants is U.S. Pat. No. 4,353,907 issued to J. B. Lovell on Oct. 12, 1982 and assigned to American Cyanamid Company now BASF Corporation. This patent discloses and claims the use of fluoro-aminido hydrazones and their bait formulations with edible oils, such as soybean oil, cottonseed oil, coconut oil, corn oil, olive oil, peanut oil, palm oil, tall oil, and their mixtures, for controlling ants.

Still another patent directed to the control of ants is U.S. Pat. No. 3,220,921 issued to Greenbaum and Weil on Nov. 30, 1965 and assigned to the Hooker Chemical Corporation. This patent disclosed and claims the dimer of hexachlorocycyopentadiene, also known as Mirex, with baits such as peanut butter. Mirex was found to be one of the most effective ant killers and was employed in solid baits such as peanut butter and ground up corn cobs because of its pronounced toxicity when ingested in the insect's digestive tract, as distinguished from its contact insecticidal activity. Although Mirex was an effective agent for killing ants it can no longer be used due to government restrictions because it is toxic to the environment.

### OBJECTS OF THE INVENTION

It is an object of this invention to provide a composition and method of making which is economical, easy and safe to use, and which is effective in killing ants, and which can be used in the environment without any dangerous effects.

It is an additional object of this invention to use compositions that have been present in the environment for extended periods of time without adverse effects thereby reducing or eliminating the need for costly testing and documentation to obtain government approval for the compositions and methods in today's society. Other objects of the invention will become apparent by the disclosures made herein.

### BRIEF DESCRIPTION OF THE INVENTION

These and other objects are accomplished by applicant's unexpected findings and invention that mixtures of Borax and powdered or icing sugar in a equal combination kills ants when the mixture is contacted with mounds of ants, as more fully described and claimed hereinafter.

### DETAILED DESCRIPTION OF THE INVENTION

In order for this invention to be more readily understood it will be described with respect to certain preferred embodiments, however it is to be understood that these embodiments are not to be construed as limiting the invention except as defined in the appended claims.

The preferred compositions of this invention are prepared by making a mixture of approximately one part of Borax which is a mixture containing sodium tetraborate decahydrate, sodium borate, or disodium tetraborate, with a quantity of powdered or icing sugar sufficient to form a composition. More particularly, significant results in killing ants can be obtained by employing a composition made from commercially available Borax such as 20 Mule Team Borax manufactured by The Dial Corporation with commercially available powdered or icing sugar, such as Bakers &Chefs manufactured by Sam's West Inc. The composition is thoroughly mixed then applied to the locus of the ant mounds by pouring, sprinkling, or sifting on the mounds.

Among the active ingredients for killing or controlling ants that may be employed in accordance with my invention are specific components of Borax and powdered or icing sugar. For example, I have found that several brands of Borax and powdered or icing sugar may be used. The above mentioned materials may be substituted for or used as partial replacements for each other, in the manner described above.

The concentrations of ingredients employed to make up the compositions of this invention may be varied widely. For example, I have found that although one part of Borax to one part of powdered or icing sugar is preferred that more or less of each may be employed and all that is required is an amount which is effective in mixing the composition.

It is to be understood that various modifications within the confines and scope of my invention are possible, some of which have been referred to above, and although I have given detailed description of my invention by illustrating specific compositions, I do not intend these to be limited thereto, except as defined by the following claims.

1. A composition for controlling ants consisting of Borax and powdered or icing sugar in selected amounts effective in killing ants in combination with, said mixture of Borax/powdered or icing sugar being in the ratio of about 1 to 1, respectively.

2. A composition in accordance with claim 1 wherein a mixing of the composition is required to facilitate the mixture.

3. A method for controlling ants which comprises applying a composition to the locus containing the ants, comprising Borax and powdered or icing sugar, in an amount effective in killing ants.

4. A method for controlling ants in accordance with claim 3 wherein the mixture of Borax and powdered or icing sugar are present in about equal proportions.

5. A method for controlling ants in accordance with claim 3 wherein the Borax and powdered or icing sugar are in proportions of about 1 to 1, respectively.
